(19) United States
(12) Patent Application Publication
(10) Pub. No.: US 2022/0146953 A1
(43) Pub. Date: May 12, 2022

(54) TONER

(71) Applicant: CANON KABUSHIKI KAISHA, Tokyo (JP)

(72) Inventors: Hirofumi Kyuushima, Tokyo (JP); Mai Kato, Tokyo (JP); Naoya Isono, Shizuoka (JP); Shintaro Noji, Shizuoka (JP); Kenichi Nakayama, Shizuoka (JP)

(21) Appl. No.: 17/515,845

(22) Filed: Nov. 1, 2021

(30) Foreign Application Priority Data
Nov. 6, 2020 (JP) 2020-185498

(51) Int. Cl. G03G 9/093

(52) U.S. Cl. CPC G03G 9/09342; G03G 9/09371; G03G 9/09364; G03G 9/09321

(57) ABSTRACT

A toner comprising a toner particle comprising a core particle comprising a binder resin, and a shell on a surface of the core particle, wherein the shell comprises an oxazoline group and a polyvalent metal, and in an electron image of a cross-section of the toner particle taken with a transmission electron microscope, the polyvalent metal has atomic concentration C(M) of 0.0010 to 0.5000 atomic % as measured by energy dispersive X-ray analysis of the shell.

### BACKGROUND OF THE INVENTION

### Field of the Invention

The present disclosure relates to a toner for use in forming toner images by developing electrostatic latent images formed by methods such as electrophotography, electrostatic recording methods and toner jet recording methods.

### Description of the Related Art

In the field of electrophotographic technology used in copiers, printers, facsimile receivers, and the like, demands from users are intensifying every year as the equipment continues to develop. In electrophotographic technology, the toner acquires a charge through triboelectric charging between the toner and various members such as the carrier and blade and is then transferred to a paper or other medium. As printing speeds have increased recent years, there has been a strong push towards improving the charge rising performance of the toner so that the desired charge can be applied to the toner in a short amount of time.

One strategy that is often used for improving the charge rising performance of the toner is to use a charge control agent or charge control resin that easily generates electric charge. For example, Japanese Patent Application Publication No. 2018-054891 discloses a core-shell toner using a resin having an oxazoline group.

### SUMMARY OF THE INVENTION

However, most charge control agents and charge control resins are highly hydrophilic and are likely to be affected by moisture adsorption and the like in high-temperature and high-humidity environments. In recent years, the use of printers has increased not only in offices but also in diverse environments including outdoor environments. When a toner is used or left for a long time in such a harsh environment, this changes the surface properties of the toner particle and reduces the charge rising performance of the toner. Therefore, problems have been found from the standpoint of the charge rising performance of the toner after being left in a harsh environment.

The present disclosure provides a toner that maintains its charge rising performance even after being left in a harsh environment and can output excellent images from the beginning of printing in an image-forming apparatus for high-speed printing.

The present disclosure relates to a toner comprising a toner particle comprising a core particle comprising a binder resin, and a shell on a surface of the core particle, wherein the shell comprises an oxazoline group and a polyvalent metal, and in an electron image of a cross-section of the toner particle taken with a transmission electron microscope, the polyvalent metal has atomic concentration C(M) of 0.0010 to 0.5000 atomic % as measured by energy dispersive X-ray analysis of the shell.

The present disclosure can provide a toner that maintains its charge rising performance even after being left in a harsh environment and can output excellent images from the beginning of printing in an image-forming apparatus for high-speed printing.

Further features of the present invention will become apparent from the following description of exemplary embodiments.

### DESCRIPTION OF THE EMBODIMENTS

Unless otherwise specified, descriptions of numerical ranges such as “at least XX but not more than YY” or “from XX to YY” in the present disclosure indicate numerical ranges that include the minimum and maximum values at either end of the range.

When a numerical range is described in stages, the upper and lower limits of each numerical range may be combined arbitrarily.

The present disclosure relates to a toner comprising a toner particle comprising
a core particle comprising a binder resin, and
a shell on a surface of the core particle, wherein
the shell comprises an oxazoline group and a polyvalent metal, and
in an electron image of a cross-section of the toner particle taken with a transmission electron microscope, the polyvalent metal has atomic concentration C(M) of 0.0010 to 0.5000 atomic % as measured by energy dispersive X-ray analysis of the shell.

The inventors discovered that the charge rising performance of a toner after being left in a harsh environment can be maintained by including an oxazoline group and a polyvalent metal in the shell.

Specifically, the shell contains an oxazoline group and a polyvalent metal, and in an electron image of a toner cross-section taken with a transmission electron microscope, the atomic concentration C(M) of the polyvalent metal as measured by energy dispersive X-ray analysis of the shell must be from 0.0010 atomic % to 0.50 atomic %.

The inventors believe that the detailed mechanism whereby the charge rising performance of the toner is maintained even after the toner has been left in a harsh environment is as follows.

Because the oxazoline groups are highly hydrophilic, they are likely to become oriented toward the toner particle surface when the toner has been left in a harsh environment such as a high-temperature and high-humidity environment. When the oxazoline groups are oriented toward the toner particle surface, charge is more likely to flow on the toner particle surface, so that charge escapes outside the toner particle and the charge rising performance is reduced.

When a polyvalent metal is present in the shell, however, it is thought that the oxazoline groups and polyvalent metal form crosslinked structures. The polyvalent metal act as a crosslinking point, inhibiting the movement of the oxazoline groups and suppressing changes to the toner particle surface even in harsh environments. The charge rising performance can be maintained even after the toner has been left in a harsh environment because changes to the toner particle surface have been suppressed.

An oxazoline group here is a group having an unopened oxazoline ring.

In an electron image of a toner particle cross-section taken with a transmission electron microscope, the atomic concentration C(M) of the polyvalent metal as measured by energy dispersive X-ray analysis must be from 0.0010 atomic % to 0.5000 atomic %.

If the C(M) is from 0.0010 atomic % to 0.5000 atomic %, good charge rising performance is obtained both at the start of printing and after the toner has been left in a harsh environment. The C(M) is preferably from 0.0030 atomic % to 0.4000 atomic %, or more preferably from 0.0100 atomic % to 0.3000 atomic %. The C(M) can be controlled by controlling the added amount of the metal.

Preferred embodiments of the toner are explained below.

The oxazoline concentration as measured by time-of-flight secondary ion mass spectrometry (TOF-SIMS) of the toner particle is preferably from 0.10 mmol/g to 10.00 mmol/g.

If the oxazoline concentration is at least 0.10 mmol/g, charge rising performance is improved. If the oxazoline concentration is not more than 10.00 mmol/g, on the other hand, electrostatic aggregation is suppressed because charging is moderate, and the flowability of the toner particle is improved. A more preferred range is from 1.0 mmol/g to 5.00 mmol/g. The oxazoline concentration can be controlled by controlling the added amount and ratio of an oxazoline group-containing monomer.

The method for including the oxazoline groups in the shell is not particularly limited. For example, the shell preferably contains a resin containing oxazoline groups. The resin containing oxazoline groups preferably contains a structure represented by formula (1) below.

The content ratio of the structure represented by formula (1) in the resin containing oxazoline groups is preferably about from 30 mass % to 98 mass %, or more preferably about from 40 mass % to 95 mass %.

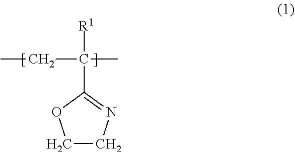

In formula (1), R¹ is a hydrogen atom or an alkyl group (preferably having from 1 to 4 carbon atoms). The alkyl group represented by R¹ is preferably a methyl group, ethyl group or isopropyl group for example. More preferably R¹ is a hydrogen atom, methyl group or ethyl group, or still more preferably a hydrogen atom or methyl group.

The structure represented by formula (1) may be introduced by using a polymerizable monomer having an oxazoline group. Specific examples include 2-vinyl-2-oxazoline and 2-isopropenyl-2-oxazoline.

The polyvalent metal contained in the shell preferably includes at least one selected from the group consisting of Mg, Al and Ca. This is because the toner color is not affected by including Mg, Al or Ca in the toner.

More preferably, the polyvalent metal is at least one selected from the group consisting of Mg and Al, which have small ion radius. A metal with a small ion radius can form crosslinking structures more easily with the oxazoline groups, making it easier to control changes to the toner particle surface after the toner has been left in a harsh environment.

The average value of the shell thickness is preferably from 1.0 nm to 15.0 nm. If the thickness of the shell layer is within this range, the charge rising performance can be improved, and problems such as toner fusion and contamination of the member due to peeling of the shell can be prevented.

A more preferred range is from 1.0 nm to 5.0 nm. The thickness of the shell layer can be controlled by controlling the added amount of the raw material for forming the shell.

The shell need not necessarily cover the entire surface of the core particle, and the core particle may also be partially exposed in some parts.

Also, the binder resin is preferably a styrene-acrylic resin. Styrene-acrylic resins have low polarity and are unlikely to adhere to members such as the developing blade and developing roller, making it possible to prevent the occurrence of development streaks due to adhesion of deteriorated toner to the various members.

Moreover, the binder resin is preferably a polyester resin. The triboelectric series is more positively charged in a polyester resin than in a styrene or acrylic resin, and charge rising performance is improved with a positively charged toner.

Oxazoline groups also react with carboxy groups to form amide bonds. If the core particle contains carboxy groups, amide bonds form between the carboxy groups of the core particle and the oxazoline groups of the shell, and it is possible to improve the film adhesiveness and suppress harmful effects caused by peeling of the shell.

From the standpoint of reacting the oxazoline groups with the carboxy groups, the acid value of the binder resin is preferably from 1.0 mg KOH/g to 30.0 mg KOH/g. If the acid value of the binder resin is at least 1.0 mg KOH/g, adhesiveness between the shell layer and the binder resin is improved. If it is not more than 30.0 mg KOH/g, on the other hand, it is possible to reduce warpage between the core and shell due to excess crosslinking, and to prevent harmful effects such as toner fusion due to toner breakage. The acid value of the binder resin is more preferably from 3.0 mg KOH/g to 30.0 mg KOH/g, or still more preferably from 8.0 mg KOH/g to 15.0 mg KOH/g. The acid value of the binder resin can be controlled by controlling the types and amounts of the raw materials used.

The method for manufacturing the toner particle is not particularly limited. From the standpoint of introducing the polyvalent metal efficiently into the shell, it is preferably a method of manufacturing the toner particle in an aqueous medium, such as a suspension polymerization method, emulsion aggregation method, dissolution suspension method or the like.

In suspension polymerization, the dispersion stabilizer for the toner particle may be a known inorganic or organic dispersion stabilizer, but preferably an inorganic dispersion stabilizer is used as a poorly water-soluble inorganic fine particle. An organic dispersion stabilizer (such as a surfactant) may also be used in combination with a poorly water-soluble inorganic fine particle.

In the toner particle granulation step, the poorly water-soluble inorganic fine particle serves as a dispersion stabilizer for a polymerizable monomer composition existing in a dispersion. A poorly water-soluble fine particle here is one having a solubility (measurement temperature: 60° C.) of not more than 10 in water at a specific pH range (such as from 4.0 to 10.0) and an average volume particle diameter of not more than 1.0 μm.

Examples of poorly water-soluble inorganic fine particles include inorganic dispersion stabilizers (poorly water-soluble inorganic dispersion stabilizers) such as calcium phosphate, magnesium phosphate, aluminum phosphate, zinc phosphate, magnesium carbonate, calcium carbonate, calcium hydroxide, magnesium hydroxide, aluminum hydroxide, calcium metasilicate, calcium sulfate, barium sulfate, bentonite, silica and alumina.

Of these, magnesium hydroxide is preferred for obtaining a sharp particle size distribution and easily introducing metal element into the shell. When preparing magnesium hydroxide particles, residual magnesium remains in the water. If residual magnesium is present in the water when an oxazoline group-containing compound is added to form the shell, the magnesium is introduced into the interior of the shell containing the oxazoline groups. A detailed manufacturing example is explained below.

In emulsion polymerization, on the other hand, a toner particle can be formed in an aqueous medium by adding a pH adjuster, a flocculant, a stabilizer and the like to the aqueous medium when aggregating and coalescing emulsified particles, and then applying temperature, mechanical force and the like as appropriate.

Examples of pH adjusters include alkalis such as ammonia, sodium hydroxide and sodium hydrogen carbonate, and acids such as nitric acid, citric acid, and the like.

Examples of flocculants include monovalent metal salts of sodium, potassium and the like; divalent metal salts of calcium, magnesium and the like; trivalent metal salts of iron, aluminum and the like; and alcohols such as methanol, ethanol and propanol. Specifically, aluminum sulfate or the like may be used.

Examples of stabilizers include primarily polar surfactants by themselves or aqueous media containing such surfactants. For example, a cationic stabilizer may be selected when the polar surfactant contained in each particle dispersion is anionic.

One kind each or two or more kinds each of these pH adjusters, flocculants and stabilizers may be used.

Of these, aluminum sulfate and magnesium chloride are preferred for easily introducing the polyvalent metal into the shell. A polyvalent metal can be introduced into the interior of a shell containing oxazoline groups by adding an oxazoline-containing compound in water in the presence of a flocculant containing a polyvalent metal to thereby form the shell.

The polyvalent metal is preferably Mg derived from magnesium hydroxide, Mg derived from magnesium chloride or Al derived from aluminum sulfate.

Binder Resin

There are no particular limits on what resin may be used as the binder resin, and a resin used in conventional toners may be used. Examples include polyester resins, vinyl resins, polyamide resins, furan resins, epoxy resins, xylene resins, silicone resins and the like.

Preferably the binder resin contains at least one selected from the group consisting of the vinyl resins and polyester resins.

Of the vinyl resins, a styrene-acrylic resin is preferred. Examples of styrene-acrylic resins include copolymers of the following styrene monomers and unsaturated carboxylic acid esters.

Examples of polymerizable monomers capable of forming the vinyl resin include styrene monomers such as styrene, α-methyl styrene and divinyl benzene; unsaturated carboxylic acid esters such as methyl acrylate, butyl acrylate, methyl methacrylate, 2-hydroxyethyl methacrylate, t-butyl methacrylate and 2-ethylhexyl methacrylate; unsaturated carboxylic acids such as acrylic acid and methacrylic acid; unsaturated dicarboxylic acids such as maleic acid; unsaturated dicarboxylic acid anhydrides such as maleic anhydride; nitrile vinyl monomers such as acrylonitrile; halogen-containing vinyl monomers such as vinyl chloride; and nitro vinyl monomers such as nitrostyrene and the like. One of these alone or a combination of multiple kinds may be used.

When using a polyester resin, a known polyester resin may be used. Specific examples include polycondensates of dibasic acids and their derivatives (carboxylic acid halides, esters, acid anhydrides) and dihydric alcohols. Trivalent and higher polybasic acids and their derivatives (carboxylic acid halides, esters, acid anhydrides), monobasic acids, trihydric and higher alcohols, and monohydric alcohols and the like may also be used as necessary.

Examples of dibasic acids include aliphatic dibasic acids such as maleic acid, fumaric acid, itaconic acid, oxalic acid, malonic acid, succinic acid, dodecylsuccinic acid, dodecenylsuccinic acid, adipic acid, azelaic acid, sebacic acid and decane-1,10-dicarboxylic acid; and aromatic dibasic acids such as phthalic acid, tetrahydrophthalic acid, hexahydrophthalic acid, tetrabromophthalic acid, tetrachlorophthalic acid, HET acid, hymic acid, isophthalic acid, terephthalic acid and 2,6-naphthalenedicarboxylic acid and the like.

Examples of dibasic acid derivatives include carboxylic acid halides, ester compounds and acid anhydrides of the above aliphatic dibasic acids and aromatic dibasic acids.

Examples of dihydric alcohols include acyclic aliphatic diols such as ethylene glycol, 1,2-propanediol, 1,3-propanediol, 1,4-butanediol, 1,5-pentanediol, 1,6-hexanediol, diethylene glycol, dipropylene glycol, triethylene glycol and neopentyl glycol; bisphenols such as bisphenol A and bisphenol F; bisphenol A alkylene oxide adducts such as bisphenol A ethylene oxide adducts and bisphenol A propylene oxide adducts; and aralkylene glycols such as xylylene diglycol and the like.

Examples of trivalent and higher polybasic acids and their anhydrides include trimellitic acid, trimellitic anhydride, pyromellitic acid, pyromellitic anhydride and the like.

As discussed above, the shell preferably contains a resin containing oxazoline groups, and the resin containing oxazoline groups preferably contains a structure represented by formula (1).

The resin containing oxazoline groups is preferably a vinyl resin. In addition to the polymerizable monomers for forming the structure represented by formula (1) having oxazoline groups, the mentioned polymerizable monomers may also be used as polymerizable monomers capable of forming the vinyl resin.

A copolymer of an unsaturated carboxyloic acid ester with an oxazoline-containing monomer such as 2-vinyl-2-oxazoline or 2-isopropenyl-2-oxazoline is preferred.

The content of the shell in the toner particle is preferably about from 0.5 mass parts to 8.0 mass parts or more preferably about from 1.0 mass part to 4.0 mass parts per 100 mass parts of the core particle.

Colorant

A colorant may also be used in the toner.

Examples of colorants include the following.

Examples of black colorants include carbon black and blacks obtained by blending yellow, magenta, and cyan colorants. A pigment may be used alone as the colorant, but considering the image quality of full-color images, it is desirable to use a dye and a pigment together to improve sharpness.

Examples of magenta coloring pigments include C.I. pigment red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. pigment violet 19; and C.I. vat red 1, 2, 10, 13, 15, 23, 29 and 35.

Examples of magenta coloring dyes include oil-soluble dyes such as C.I. solvent red 1, 3, 8, 23, 24, 25, 27, 30, 49, 81, 82, 83, 84, 100, 109 and 121, C.I. disperse red 9, C.I. solvent violet 8, 13, 14, 21 and 27 and C.I. disperse violet 1; C.I. basic red 1, 2, 9, 12, 13, 14, 15, 17, 18, 22, 23, 24, 27, 29, 32, 34, 35, 36, 37, 38, 39 and 40; and basic dyes such as C.I. basic violet 1, 3, 7, 10, 14, 15, 21, 25, 26, 27 and 28 and the like.

Examples of cyan coloring pigments include C.I. pigment blue 2, 3, 15:2, 15:3, 15:4, 16 and 17, C.I. vat blue 6; and C.I. acid blue 45 and copper phthalocyanine pigments having 1 to 5 phthalimidomethyl groups substituted in the phthalocyanine skeleton.

An example of a cyan coloring dye is C.I. solvent blue 70.

Examples of yellow coloring pigments include C.I. pigment yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185, and C.I. vat yellow 1, 3 and 20.

An example of a yellow coloring dye is C.I. solvent yellow 162.

The amount of the colorant used is preferably from 0.1 mass parts to 30.0 mass parts per 100.0 mass parts of the binder resin.

Wax

The toner preferably contains a wax. Examples of the wax include hydrocarbon waxes such as low-molecular-weight polyethylene, low-molecular-weight polypropylene, alkylene copolymers, microcrystalline wax, paraffin wax and Fischer-Tropsch wax; hydrocarbon wax oxides such as polyethylene oxide wax, or block copolymers of these; waxes consisting primarily of fatty acid esters, such as carnauba wax; and partially or fully deoxidized fatty acid esters, such as deoxidized carnauba wax.

Other examples include saturated linear fatty acids such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and myricyl alcohol; polyhydric alcohols such as sorbitol; esters of fatty acids such as palmitic acid, stearic acid, behenic acid and montanic acid with alcohols such as stearyl alcohol, aralkyl alcohol, behenyl alcohol, carnaubyl alcohol, ceryl alcohol and myricyl alcohol; fatty acid amides such as linoleamide, oleamide and lauramide; saturated fatty acid bisamides such as methylene bis-stearamide, ethylene bis-caproamide, ethylene bis-lauramide and hexamethylene bis-stearamide; unsaturated fatty acid amides such as ethylene bis-oleamide, hexamethylene bis-oleamide, N,N′-dioleyl adipamide and N,N′-dioleyl sebacamide; aromatic bisamides such as m-xylene bis-stearamide and N,N′-distearyl isophthalamide; fatty acid metal salts (commonly called metal soaps) such as calcium stearate, calcium laurate, zinc stearate and magnesium stearate; waxes obtained by grafting vinyl monomers such as styrene and acrylic acid to aliphatic hydrocarbon waxes; partial ester compounds of fatty acids and polyhydric alcohols, such as behenyl monoglyceride; and methyl ester compounds having hydroxyl groups obtained by hydrogenation of vegetable oils and fats.

Of these waxes, a hydrocarbon wax such as paraffin wax or Fischer-Tropsch wax is preferable for improving low-temperature fixability and preventing property for winding of a recording medium during fixing.

The content of the wax is preferably from 0.5 mass parts to 25.0 mass parts per 100.0 mass parts of the binder resin.

To give the toner both storability and hot offset resistance, the peak temperature of the maximum endothermic peak in the temperature range of from 30° C. to 200° C. in an endothermic curve obtained during temperature rise in measurement by differential scanning calorimeter (DSC) is preferably from 50° C. to 110° C.

Charge Control Agent

The toner may contain a charge control agent as necessary. A known charge control agent may be used.

The charge control agent may be added either internally or externally to the toner particle.

The added amount of the charge control agent is preferably from 0.2 mass parts to 10.0 mass parts per 100.0 mass parts of the binder resin.

Carrier

The toner may also be mixed with a magnetic carrier and used as a two-component developer in order to obtain stable images over a long period of time.

Examples of magnetic carriers include the following known carriers: surface oxidized iron powders, unoxidized iron powders, metal particles of iron, lithium, calcium, magnesium, nickel, copper, zinc, cobalt, manganese, chromium, rare earths and the like, alloy particles and oxide particles of these, magnetic bodies such as ferrite, and magnetic-dispersed resin carriers (so-called resin carriers) containing magnetic bodies and a binder resin that holds the magnetic bodies in a dispersed state.

Any method may be used for manufacturing the toner particle. For example, this may be a method of manufacturing the toner directly in a hydrophilic medium, such as an emulsion aggregation method, dissolution suspension method or suspension polymerization method. A pulverization method may also be used, and a toner obtained by a pulverization method may also be subjected to heat sphering treatment.

A manufacturing method using a pulverization method is explained below.

In the pulverization method, a resin as an essential component is mixed together with optional components such as a colorant, wax, charge control agent and the like, and the resulting mixture is melt kneaded. The resulting melt kneaded product is then pulverized and classified to obtain a core particle with the desired particle diameter.

The preferred method of forming the shell coating the core particles is to disperse the core particle in an aqueous medium and then adding the materials for forming the shell to the aqueous medium.

Methods for properly dispersing the core particle in the aqueous medium after the core particle is added to the aqueous medium include methods of mechanically dispersing the core particle in the aqueous medium using a device capable of strongly agitating the dispersion, and methods of dispersing the core particle in an aqueous medium containing a dispersant. A method using a dispersant is useful for forming a shell without exposing the surface of the core particle because it allows the core particle to be dispersed uniformly in the aqueous medium.

A device such as a Hivis Mix (Primix Corp.) is preferred as the device capable of strongly agitating the dispersion.

The temperature when forming the shell is preferably at least 65° C., or more preferably at least 70° C. By forming the shell at this temperature range, it is possible to suppress coalescence of the formed toner particles with each other while making good progress in shell formation.

Once the shell has been formed as described above, the dispersion containing the core particle covered with the shell can be cooled to room temperature to obtain a dispersion of the toner particle. A washing step of washing the toner particle, a drying step of drying the toner particle, and an external addition step of attaching an external additive to the surface of the toner particle may then be performed as necessary to obtain the toner.

An external additive may be attached as necessary to the surface of the toner particle. A good method for attaching an external additive to the surface of a toner particle obtained by the above methods is to mix the toner particle and the external additive in a mixer such as an FM mixer (Nippon Coke & Engineering) with the conditions adjusted so that the external additive does not become embedded in the surface of the toner particle.

The methods for measuring the various physical properties are explained below.

Identifying Resins Contained in Core Particle and Shell

The compositions and ratios of the constituent compounds of the resins contained in the core particle and the shell are identified by pyrolysis gas chromatography mass spectrometry (hereunder also called “pyrolysis GC/MS”) and NMR. If the resins constituting the core and the shell can be obtained independently then they may be measured independently.

Pyrolysis GC/MS is used to analyze the types of constituent compounds in the resin. The types of constituent compounds are identified by analyzing a mass spectrum of the components of a resin decomposition product obtained by pyrolyzing the resin at 550° C. to 700° C. The specific measurement conditions are as follows.

Measurement Conditions for Pyrolysis GC/MS

### Pyrolysis Unit: JPS-700 (Japan Analytical Industry)

Decomposition temperature: 590° C.
GC/MS unit: Focus GC/ISQ (Thermo Fisher)
Column: HP-SMS, length 60 m, internal diameter 0.25 mm, film thickness 0.25 μm
Injection port temperature: 200° C.
Flow pressure: 100 kPa
Split: 50 mL/min
MS ionization: EI
Ion source temperature: 200° C., mass range 45-650

The abundance ratios of the identified constituent compounds of the resin are then measured and calculated by solid ¹H-NMR. Structural determination is performed by nuclear magnetic resonance spectroscopic analysis (¹H-NMR) (400 MHz, CDCl₃, room temperature (25° C.)).

Measurement equipment: JNM-EX400 FT NMR unit (JEOL)
Measurement frequency: 400 MHz
Pulse condition: 5.0 μs
Frequency range: 10,500 Hz
Cumulative number: 1,024 times

The molar ratios of the monomer components are determined from the integral values of the resulting spectrum and used to calculate the compositional ratios (mass %).

Isolating Toner Particle from Toner

When the toner particle will be used as the sample, a toner particle obtained by removing the external additive from the toner by the following methods may be used.

(1) 5 g of the toner with the added external additive is placed in a sample bottle, and 200 mL of methanol is added. A few drops of a surfactant may also be added as necessary. “Contaminon N” (a 10 mass % aqueous solution of a pH 7 neutral detergent for cleaning precision measurement instruments, comprising a non-ionic surfactant, an anionic surfactant, and an organic builder, manufactured by Wako Pure Chemical Industries) may be used as the surfactant.

(2) The sample is dispersed for 5 minutes with an ultrasound cleaner to separate the external additive.

(3) This is suction filtered with a 10 μm membrane filter to separate the external additive from the toner particle.

(4) (2) and (3) above are performed three times.

A toner particle obtained by removing the external additive from the toner can be obtained by these operations.

Measuring Amount of Metal in Shell of Toner Particle

Using a transmission electron microscope (TEM), the content of the polyvalent metal is measured as follows from an electron image of a cross-section of the toner particle.

For the measurement sample, the toner is mixed with a visible light curable embedding resin (D-800, Nisshin EM), and pressure molded with a tablet molder in a 25° C. environment into a disk 7.9 mm in diameter and 1.0±0.3 mm thick to obtain a sample of embedded toner. The pressure molding conditions are 35 MPa, 60 seconds. A flake-shaped sample with a film thickness of 100 nm is cut from this sample at a cutting speed of 0.6 mm/s using an Ultramicrotome (EM UC7, Leica) equipped with a diamond blade.

This sample is observed at a magnification of 500,000 using a transmission electron microscope (TEM) (JEM2800, JEOL) at an acceleration voltage of 200 V and an electron beam probe size of 1 mm to observe the toner particle in cross-section. Cross-sections having long axes corresponding to the weight-average particle diameter (D4) of the observed toner particle ±10% are observed.

The shell and core particle can be distinguished based on the types and concentrations of the constituent elements in the core and shell. For example, when the shell contains oxazoline groups and the core particle is a polyester resin, a region containing nitrogen atoms can be judged to be the shell because oxazoline groups contain nitrogen.

A spectrum is then collected from energy dispersive X-ray analysis (EDS: NSS Thermo Electron) for the constituent elements of the resulting toner particle cross-section.

The interior of the shell is subjected to quantitative analysis by the Cliff-Lorimer method, the polyvalent metal content C(M) atomic % is measured at 10 points in the shell interior of the same toner particle, and the average value is calculated. The C(M) atomic % represents an atomic weight fraction given 100% as the amount of all elements detected during analysis. The conditions for analysis by the Cliff-Lorimer method are a qualitative sensitivity of 5, an overvoltage of 1.5 keV and a number of oxygen atoms of 0, and matrix correction is performed to correct for the effect of coexisting elements.

These measurements are performed on 20 toner particles, and the arithmetic average is used.

Means for Excluding Effects of Polyvalent Metal Contained in External Additive

When an external additive containing a polyvalent metal is attached to the toner particle, the effects of polyvalent metal derived from the external additive can be excluded by the following method.

The shape of the external additive can be specified from the constituent atoms of the external additive. In the observed toner particle cross-section, the external additive is avoided and only regions of shell are selected, and a spectrum from energy dispersive X-ray analysis is collected.

Measuring Average Value of Shell Thickness

For the measurement sample, the toner is mixed with a visible light curing embedding resin (D-800, Nisshin EM), and pressure molded with a tablet molder in a 25° C. environment into a disk 7.9 mm in diameter and 1.0±0.3 mm thick to obtain a sample of embedded toner. The pressure molding conditions are 35 MPa, 60 seconds.

A flake-shaped sample with a film thickness of 100 nm is cut from this sample at a cutting speed of 0.6 mm/s using an Ultramicrotome (EM UC7, Leica) equipped with a diamond blade. The resulting sample is stained with osmium tetroxide. This operation serves to selectively stain only the shell of the toner particle.

The resulting flake-shaped sample is observed in cross-section at a magnification of 500,000 using a transmission electron microscope (TEM) (JEM2800, JEOL) with an acceleration voltage of 200 V and an electron beam probe size of 1 mm. The TEM images are then analyzed with image analysis software to determine the shell thickness.

Specifically, two straight lines are drawn intersecting at right angles roughly in the center of the toner particle cross-section, and the shell thickness is measured at each of the four points where these two straight lines intersect the shell. The arithmetic average of the thickness measurements at these four points is given as the thickness of the toner particle shell. The shell thickness of 20 toner particles is measured in this way, and the number average of the measured thicknesses is given as the evaluation value (average value of shell thickness) for the toner to be measured.

Method for Measuring Weight-average Particle Diameter (D4) of Toner Particle

The weight-average particle diameter (D4) of the toner particle is measured with 25,000 effective measurement channels using a Coulter Counter Multisizer 3 (registered trademark, Beckman Coulter) precision particle size distribution measurement apparatus based on the pore electrical resistance method and equipped with a 100 μm aperture tube together with the Beckman Coulter Multisizer 3 Version 3.51 dedicated accessory software (Beckman Coulter) for setting the measurement conditions and analyzing the measurement data, and the measurement data are analyzed.

The electrolytic aqueous solution used for measurement is a solution of special grade sodium chloride dissolved in deionized water to a concentration of about 1 mass %, such as Isoton II (Beckman Coulter) for example.

The dedicated software is set up in the following manner before the measurement and analysis.

The total count number in a control mode is set to 50,000 particles on a “CHANGE STANDARD MEASUREMENT METHOD (SOM) SCREEN” of the dedicated software, the number of measurements is set to 1, and a value obtained using “standard particles 10.0 μm” (manufactured by Beckman Coulter) is set as a Kd value. The threshold and the noise level are automatically set by pressing the measurement button of the threshold/noise level. Further, the current is set to 1600 μA, the gain is set to 2, the electrolytic solution is set to ISOTON II, and “FLUSH OF APERTURE TUBE AFTER MEASUREMENT” is checked.

In the “PULSE TO PARTICLE DIAMETER CONVERSION SETTING SCREEN” of the dedicated software, the bin interval is set to a logarithmic particle diameter, the particle diameter bin is set to a 256-particle diameter bin, and a particle diameter range is set from 2 μm to 60 μm.

A specific measurement method is described hereinbelow.

(1) Approximately 200 mL of the electrolytic aqueous solution is placed in a glass 250 mL round-bottom beaker dedicated to Multisizer 3, the beaker is set in a sample stand, and stirring with a stirrer rod is carried out counterclockwise at 24 rpm. Dirt and air bubbles in the aperture tube are removed by the “FLUSH OF APERTURE” function of the dedicated software.

(2) 30 mL of the electrolytic aqueous solution is placed in a 100 mL flat-bottomed beaker, and about 0.3 mL of the following diluted solution is added thereto as a dispersant.
Diluted solution: “Contaminon N” (a 10 mass % aqueous solution of a pH 7 neutral detergent for cleaning precision measurement instruments, comprising a non-ionic surfactant, an anionic surfactant, and an organic builder, manufactured by Wako Pure Chemical Industries) diluted 3 times by mass with deionized water.

(3) A predetermined amount of deionized water is placed in the water tank of the following ultrasound disperser, which has an electrical output of 120 W and is equipped with two oscillators with an oscillation frequency of 50 kHz built in with their phases shifted by 180 degrees, and about 2 mL of the previous Contaminon N is then added to the water tank.
Ultrasound disperser: Ultrasonic Dispersion System Tetra 150 (Nikkaki Bios)

(4) The beaker of (2) hereinabove is set in the beaker fixing hole of the ultrasound disperser, and the ultrasound disperser is actuated. Then, the height position of the beaker is adjusted so that the resonance state of the liquid surface of the electrolytic aqueous solution in the beaker is maximized.

(5) About 10 mg of the toner is added little by little to the electrolytic aqueous solution and dispersed therein in a state in which the electrolytic aqueous solution in the beaker of (4) hereinabove is irradiated with ultrasound waves. Then, the ultrasound dispersion process is further continued for 60 sec. In the ultrasound dispersion, the water temperature in the water tank is appropriately adjusted to a temperature from 15° C. to 40° C.

(6) The electrolytic aqueous solution of (5) hereinabove in which the toner is dispersed is dropped using a pipette into the round bottom beaker of (1) hereinabove which has been set in the sample stand, and the measurement concentration is adjusted to be about 5%. Then, measurement is conducted until the number of particles to be measured reaches 50,000.

(7) The measurement data are analyzed with the dedicated software provided with the apparatus, and the weight average particle diameter (D4) is calculated. The weight-average particle diameter (D4) is the “average diameter” on the analysis/volume statistics (arithmetic mean) screen when graph/vol % is set on the dedicated software.

Measuring Oxazoline Concentration of Toner Particle

The oxazoline concentration of the toner particle surface is measured by TOF-SIMS (Ulvac-Phi, TRIFT-IV). The analysis conditions are as follows.

Sample preparation: Toner particle is affixed to indium sheet

Sample pre-treatment: None

Primary ion: Au⁺

Acceleration voltage: 30 kV

Charge neutralization mode: On

Measurement mode: Positive

Raster size: 100 μm

Cumulative time: 180 seconds

The oxazoline group concentration is calculated from the intensity derived from oxazoline groups in a secondary ion mass spectrum obtained under the above conditions (vertical axis: normalized intensity, horizontal axis: mass number=m/z) using a calibration curve prepared based on samples of known concentration. The normalized intensity is determined from (mass spectrum intensity derived from oxazoline groups)/(total of all ion intensities at mass number m/z=1 to 1850). Specifically, at least three samples with known concentrations are prepared and used to prepare a calibration curve (vertical axis: concentration=mmol/g, horizontal axis: normalized intensity). The oxazoline concentration is determined based on the calibration curve from the normalized intensity obtained from oxazoline groups in the toner particle.

Acid Value

The acid value of resin such as the binder resin is the number of milligrams of potassium hydroxide required to neutralize the acid contained in 1 g of the sample. The acid value of polar resin is measured according to JIS K 0070-1992. Specifically, the acid value is measured according to the following procedure.

Titration is carried out using 0.1 mol/L potassium hydroxide ethyl alcohol solution (manufactured by Kishida Chemical Co., Ltd.). The factor of the potassium hydroxide ethyl alcohol solution can be obtained using a potentiometric titration apparatus (potentiometric titration apparatus AT-510 (product name) manufactured by Kyoto Electronics Industry Co., Ltd.).

A total of 100 mL of 0.100 mol/L hydrochloric acid is taken in a 250 mL tall beaker and titrated with the potassium hydroxide ethyl alcohol solution, and the acid value is determined from the amount of the potassium hydroxide ethyl alcohol solution required for neutralization. The 0.100 mol/L hydrochloric acid is prepared according to JIS K 8001-1998.

Measurement conditions for acid value measurement are shown below.

Titration apparatus: potentiometric titration apparatus AT-510 (product name, manufactured by Kyoto Electronics Industry Co., Ltd.)
Electrode: composite glass electrode of double junction type (manufactured by Kyoto Electronics Industry Co., Ltd.)
Control software for titrator: AT-WIN
Titration analysis software: Tview

Titration parameters and control parameters during titration are as follows.

### Titration Parameters

Titration mode: blank titration
Titration scheme: full amount titration
Maximum titration amount: 20 mL
Wait time before titration: 30 sec
Titration direction: automatic

### Control Parameters

End point determination potential: 30 dE
End point determination potential value: 50 dE/dmL
End point detection determination: not set
Control speed mode: standard

### Gain: 1

Data collection potential: 4 mV
Data collection titration amount: 0.1 mL

Main Test:

A total of 0.100 g of the measurement sample is accurately weighed in a 250 mL tall beaker, 150 mL of a mixed solution of toluene/ethanol (3:1) is added, and dissolution is carried out over 1 h. Titration is carried out using the potentiometric titration apparatus and the potassium hydroxide ethyl alcohol solution.

Blank Test:

Titration is performed in the same manner as described hereinabove except that no sample is used (that is, only a mixed solution of toluene/ethanol (3:1) is used).

The obtained result is substituted into the following formula to calculate the acid value (Av).

Av=[(C−B)×f×5.61]/S

(in the formula, Av: acid value (mg KOH/g), B: addition amount (mL) of the potassium hydroxide ethyl alcohol solution in the blank test, C: addition amount (mL) of the potassium hydroxide ethyl alcohol solution in the main test, f: factor of potassium hydroxide ethyl alcohol solution, S: mass of the sample (g)).

### EXAMPLES

The present invention is explained in more detail below based on examples. The present invention is not limited by the following examples. Unless otherwise specified, parts and % values in the examples and comparative examples are based on mass.

Manufacturing Polyester Resin 1 for Core Particle

Monomers in the amounts shown in Table 1 were placed in a reaction tank equipped with a nitrogen introduction pipe, a dewatering pipe, a stirrer, and a thermocouple, and dibutyl tin oxide was added as a catalyst in the amount of 1.5 parts per 100 parts of the total monomers. The temperature was then rapidly raised to 180° C. at normal pressure in a nitrogen atmosphere, and the mixture was heated from 180° C. to 210° C. at a rate of 10° C./hour as the water was distilled off to perform polycondensation.

Once the temperature had reached 210° C., the pressure inside the reaction tank was lowered to not more than 5 kPa less, and polycondensation was performed at 210° C., not more than 5 kPa to obtain a polyester resin 1.

Manufacturing Polyester Resins 2 and 3 for Core Particle

Polyester resins 2 and 3 were prepared by the same manufacturing methods as the polyester resin 1 except that the raw materials were changed as shown in Table 1.

TABLE 1

| | | Polyester | Polyester | Polyester |
|---|---|---|---|---|
| | | resin 1 | resin 2 | resin 3 |
| Monomer | Terephthalic acid | 47 | 47 | 45 |
| composition | Fumaric acid | 35 | 37 | 40 |
| input | Dodecenylsuccinic | 15 | 15 | 15 |
| (molar ratios) | acid | | | |
| | Trimellitic acid | 1 | 5 | 10 |
| | BPA-PO | 60 | 60 | 60 |
| | BPA-EO | 40 | 40 | 40 |
| Physical | Acid value | 2.5 | 14.5 | 30.8 |
| properties | (mgKOH/g) | | | |
| of resin | Tg (° C.) | 59 | 60 | 62 |

The abbreviations in the table are defined as follows.

BPA-PO: Bisphenol A propylene oxide 2-mol adduct
BPA-EO: Bisphenol A ethylene oxide 2-mol adduct

Manufacturing Toner 1

### Preparing Dispersion

10.2 parts of magnesium chloride were dissolved in 250.0 parts of deionized water in a granulation tank to prepare an aqueous magnesium chloride solution. An aqueous solution of 6.2 parts of sodium hydroxide dissolved in 50.0 parts of deionized water was gradually added to the granulation tank under stirring at a peripheral speed of 25 m/s with a TK Homomixer (product name, Tokushu Kika) to obtain a dispersion containing magnesium hydroxide (fine particles).

Preparing Pigment-dispersed Composition

| | |
|---|---|
| Polymerizable monomer (styrene) | 39.0 parts |
| Colorant (C.I. pigment blue 15:3) | 7.0 parts |

These materials were introduced into an attritor (Nippon Coke), and stirred for 180 minutes at 200 rpm, 25° C. with zirconia beads with a radius of 1.25 mm to prepare a pigment-dispersed composition.

Preparing Colorant-containing Composition

The following materials were placed in the same container, and mixed and dispersed at a peripheral speed of 20 m/s with a TK Homomixer (product name, Tokushu Kika).

| | |
|---|---|
| Above pigment-dispersed composition | 46.0 parts |
| Polymerizable monomer: Styrene | 31.0 parts |
| Polymerizable monomer: n-butyl acrylate | 30.0 parts |
| Charge control agent: FCA-5 (product name, Fujikura Kasei) | 1.2 parts |
| Crosslinking agent: Divinyl benzene | 0.5 parts |

This was then heated to 60° C., 10.0 parts of behenyl behenate as the release agent were added, and the mixture was dispersed and mixed for 30 minutes to prepare a colorant-containing composition.

Preparing Polymerizable Monomer Composition Particle

The above colorant-containing composition was added to the dispersion containing magnesium hydroxide fine particles, and stirred at a peripheral speed of 30 m/s in a TK Homomixer (product name, Tokushu Kika) at 60° C. in a nitrogen atmosphere. 9.0 parts of t-butyl peroxypivalate (NOF Corp. Perbutyl PV (product name), molecular weight 174.2, 10-hour half-life temperature 58° C.) as the polymerization initiator were added to prepare a dispersion containing particles of a polymerizable monomer composition.

The above dispersion containing particles of a polymerizable monomer composition was transferred to a separate tank, and the temperature was raised to 70° C. under stirring with a paddle stirring blade to perform a polymerization reaction.

Once the conversion rate of the polymerizable monomers had reached 95%, the temperature was raised to 90° C., and 0.2 parts of methyl methacrylate and 1.8 parts of 2-vinyl-2-oxazoline were added as polymerizable monomers for the shell together with an aqueous solution of 0.2 parts of 2,2′-azobis(N-butyl-2-methylpropionamide) dissolved in 10 parts of deionized water as a water-soluble initiator. This was polymerized for 3 hours at 90° C. to obtain a polymer reaction solution (polymer slurry) containing a toner particle 1.

This was cooled, sulfuric acid was added to lower the pH to 6.5 or less, and the mixture was stirred for 2 hours to dissolve the poorly water soluble inorganic fine particles on the toner particle surface. A dispersion of the toner particle was filtered out, water washed, and dried for 48 hours at 40° C. to obtain a toner particle 1 having a core-shell structure and a weight-average particle diameter (D4) of 6.8 μm.

External Addition Step

100.0 parts of the toner particle 1 and 1.5 parts of a dry process silica particle (Nippon Aerosil Co., Ltd. AEROSIL (registered trademark) REA90: positively charged hydrophobically treated silica particle) were mixed for 3 minutes with an FM Mixer (Nippon Coke & Engineering) to attach the silica particle to the toner particle 1. This was then sieved with a #300 mesh (mesh size 48 μm) to obtain a toner 1.

Manufacturing Toner 2

A toner 2 was obtained in the same way as the toner 1 except that 0.4 parts of methyl methacrylate and 3.6 parts of 2-vinyl-2-oxazoline as polymerizable monomers for the shell were added together with an aqueous solution of 0.4 parts of 2,2′-azobis(N-butyl-2-methylpropionamide) dissolved in 10 parts of deionized water as a water-soluble initiator when preparing the toner 1 polymerizable monomer composition particle, and an aqueous solution of 0.5 parts of magnesium chloride dissolved in 5.0 parts of deionized water was further added.

Manufacturing Toner 3

A toner 3 was obtained in the same way as the toner 1 except that 0.8 parts of methyl methacrylate and 7.2 parts of 2-vinyl-2-oxazoline as polymerizable monomers for the shell were added together with an aqueous solution of 0.8 parts of 2,2′-azobis(N-butyl-2-methylpropionamide) dissolved in 20 parts of deionized water as a water-soluble initiator when preparing the toner 1 polymerizable monomer composition particle, and an aqueous solution of 1.0 part of magnesium chloride dissolved in 5.0 parts of deionized water was further added.

Manufacturing Toner 4

A toner 4 was obtained in the same way as the toner 1 except that 30 parts of an aqueous solution of an oxazoline-containing resin for the shell (Nippon Shokubai Epocros WS-300, solids concentration of 10 mass %) were added instead of the polymerizable monomers for the shell when preparing the toner 1 polymerizable monomer composition particle.

Manufacturing Toner 5

### Manufacturing Polyester Resin A

The following materials were added to an autoclave equipped with a decompressor, a water separator, a nitrogen gas introduction device, a temperature measurement device, and a stirring device.

| | |
|---|---|
| Terephthalic acid | 32.3 parts (50.0 mol %) |
| Bisphenol A propylene oxide 2-mol adduct | 67.7 parts (50.0 mol %) |
| Titanium potassium oxalate (catalyst): | 0.02 parts |

A reaction was then performed at 220° C. under normal pressure in a nitrogen atmosphere until the desired molecular weight was reached. The mixture was cooled and then pulverized to obtain a polyester resin A. The polyester resin A had an acid value of 8.0 mg KOH/g.

Preparing Dispersion

100.0 parts of deionized water, 2.0 parts of sodium phosphate and 0.9 parts of 10 mass % hydrochloric acid were added to a granulation tank to prepare a sodium phosphate aqueous solution, which was then heated to 50° C. A calcium chloride aqueous solution prepared by dissolving 1.2 parts of calcium chloride hexahydrate in 8.2 parts of deionized water was added to this granulation tank, and the mixture was stirred for 30 minutes at a peripheral speed of 25 m/s with a TK Homomixer (product name, Tokushu Kika). A dispersion (aqueous dispersion) of calcium phosphate (fine particles) as a poorly water soluble inorganic fine particle was thus obtained.

Preparing Pigment-dispersed Composition

| | |
|---|---|
| Polymerizable monomer (styrene) | 39.0 parts |
| Colorant (CI. pigment blue 15:3) | 7.0 parts |

These materials were introduced into an attritor (Nippon Coke), and stirred for 180 minutes at 200 rpm, 25° C. with zirconia beads with a radius of 1.25 mm to prepare a pigment-dispersed composition.

Preparing Colorant-containing Composition

The following materials were placed in the same container, and mixed and dispersed at a peripheral speed of 20 m/s with a TK Homomixer (product name, Tokushu Kika).

| | |
|---|---|
| Above pigment-dispersed composition | 46.0 parts |
| Polymerizable monomer: Styrene | 31.0 parts |
| Polymerizable monomer: n-butyl acrylate | 30.0 parts |
| Polyester resin A | 2.0 parts |
| Crosslinking agent: Divinyl benzene | 0.5 parts |

This was then heated to 60° C., 10.0 parts of behenyl behenate as the release agent were added, and the mixture was dispersed and mixed for 30 minutes to prepare a colorant-containing composition.

Preparing Polymerizable Monomer Composition Particle

The colorant-containing composition was added to the dispersion containing calcium phosphate fine particles, and stirred at a peripheral speed of 30 m/s in a TK Homomixer (product name, Tokushu Kika) at 60° C. in a nitrogen atmosphere. 9.0 parts of t-butyl peroxypivalate (NOF Corp. Perbutyl PV (product name), molecular weight of 174.2, 10-hour half-life temperature of 58° C.) as the polymerization initiator were added to prepare a dispersion containing particles of a polymerizable monomer composition.

The above dispersion containing particles of a polymerizable monomer composition was transferred to a separate tank, the temperature was raised to 70° C. under stirring with a paddle stirring blade, and the dispersion was reacted for 5 hours at 70° C., after which the liquid temperature was raised to 85° C. and the dispersion was further reacted for 2 hours.

After completion of the reaction, the resulting slurry was cooled and left standing to precipitate the particles, and part of the supernatant was removed to obtain a core slurry with a solids concentration of 25 mass %.

Shell Formation

A 1 L 3-necked flask equipped with a thermometer and a stirring blade was set in a water bath, and 400 g of the core slurry obtained above was added to the flask. The water bath was then used to raise the temperature inside the flask to 30° C. An aqueous solution of an oxazoline group-containing resin (Nippon Shokubai Epocros WS-300, solids concentration of 10 mass %) was added to the flask in the amount shown in Table 2.

The added amount in Table 2 is the number of parts of the oxazoline group-containing resin (as solids) per 100 parts of the core particle in the core slurry.

The flask contents were then stirred for 1 hour at a rotational speed of 200 rpm. 300 g of deionized water was then added to the flask.

6 mL of a 1 mass % aqueous ammonia solution were then added to the flask.

The flask contents were then stirred at a rotational speed of 150 rpm as the temperature inside the flask was raised to 55° C. at a rate of 0.5° C./min. The flask contents were then stirred at 100 rpm as the same temperature (55° C.) was maintained for 2 hours.

An aqueous ammonia solution with a concentration of 1 mass % was then added to the flask to adjust the pH of the flask contents to 7. The resulting slurry was then cooled to room temperature (about 25° C.).

Dilute hydrochloric acid was then added under continued stirring until the pH reached 1.5 to dissolve the dispersion stabilizer. The solids were filtered out, thoroughly washed with deionized water, and vacuum dried for 24 hours at 40° C. to obtain a toner particle 5.

External Addition Step

A toner 5 was obtained in the same way in the external addition step of the toner particle 1 except that the toner particle 5 was used.

Manufacturing Toner Particle 6

### Manufacturing Core Particle

| | |
|---|---|
| Polyester resin 1: | 90.0 parts |
| C.I. pigment blue 15:3 (copper phthalocyanine): | 5.0 parts |
| Ester wax (behenyl behenate: melting point 72° C.): | 15.0 parts |
| Fischer-Tropsch wax (Sasol Co. C105, melting | 2.0 parts |
| point of 105° C.): | |

These materials were mixed in a Mitsui Henschel Mixer (Mitsui Miike) and then melt kneaded with a twin-screw extruder (product name PCM-30, Ikegai Corp.) with the temperature set so that the temperature of the melted product at the ejection port was 140° C.

The melt kneaded product was cooled, crushed coarsely with a hammer mill, and finely pulverized with a pulverizer (product name Turbomill T250, Turbo Industries). The resulting fine powder was classified with a multi-division classifier using the Coanda effect to obtain a core particle with a weight-average particle diameter (D4) of 6.8 μm.

Shell Formation

A 1 L 3-necked flask equipped with a thermometer and a stirring blade was set in a water bath, and 300 g of deionized water was added to the flask. The water bath was then used to raise the temperature inside the flask to 30° C. An aqueous solution of an oxazoline group-containing resin (Nippon Shokubai Epocros WS-300, solids concentration of 10 mass %) was added to the flask in the amount shown in Table 2. A magnesium chloride aqueous solution consisting of 0.5 parts (1.5 g) of magnesium chloride (as solids) dissolved in 10 g of deionized water was further added.

300 g of the toner core prepared by the above procedures were then added to the flask, and the flask contents were stirred for 1 hour at 200 rpm. 300 g of deionized water was added to the flask.

Next, 6 mL of an aqueous ammonia solution with a concentration of 1 mass % was added to the flask.

The flask contents were then stirred at a rotational speed of 150 rpm as the temperature inside the flask was raised to 55° C. at a rate of 0.5° C./min. The flask contents were then stirred at 100 rpm as the same temperature (55° C.) was maintained for 2 hours.

An aqueous ammonia solution with a concentration of 1 mass % was then added to the flask to adjust the pH of the flask contents to 7. The resulting slurry was then cooled to room temperature (about 25° C.), subjected to washing, filtration and solid-liquid separation, and finally dried with a vacuum drier to obtain a toner particle 6.

External Addition Step

A toner 6 was obtained in the same way as in the external addition step of the toner particle 1 except that the toner particle 6 was used.

Manufacturing Toner Particles 7 to 12

Toner particles 7 to 12 were obtained by the same manufacturing method as the toner particle 6 except that the resins were changed as shown in Table 2.

TABLE 2

| | | Aqueous solution of oxazoline | |
|---|---|---|---|
| | Core resin | group-containing polymer | |
| | Type | Type | Added amount |
| Toner 1 | Shown in Description | Shown in Description | |
| Toner 2 | Shown in Description | Shown in Description | |
| Toner 3 | Shown in Description | Shown in Description | |
| Toner 4 | Shown in Description | Epocros WS-300 | 3.0 |
| Toner 5 | Polyester resin 1 | Epocros WS-300 | 3.0 |
| Toner 6 | Polyester resin 1 | Epocros WS-300 | 3.0 |
| Toner 7 | Polyester resin 1 | Epocros WS-700 | 3.0 |
| Toner 8 | Polyester resin 1 | Epocros WS-700 | 0.8 |
| Toner 9 | Polyester resin 1 | Epocros WS-700 | 0.5 |
| Toner 10 | Polyester resin 1 | Epocros WS-300 | 10.0 |
| Toner 11 | Polyester resin 2 | Epocros WS-700 | 3.0 |
| Toner 12 | Polyester resin 3 | Epocros WS-300 | 9.0 |
| Toner 13 | Polyester resin 1 | Epocros WS-300 | 3.0 |
| Toner 14 | Polyester resin 1 | Epocros WS-300 | 3.0 |
| Toner 15 | Polyester resin 1 | Epocros WS-700 | 3.0 |
| Toner 16 | Polyester resin 1 | Epocros WS-700 | 3.0 |
| Toner 17 | Shown in Description | None | None |
| Toner 18 | Shown in Description | Shown in Description | |
| Toner 19 | Polyester resin 1 | Epocros WS-700 | 0.5 |

The added amounts in Table 2 are parts of the oxazoline group-containing resin (as solids) per 100 parts of the core particle.

Toner Particle 13

### Preparing Dispersion of Polyester Resin Particle

| | |
|---|---|
| Polyester resin 1 | 200 parts |
| Deionized water | 500 parts |

These materials were placed in a stainless-steel container, heated to 95° C. and melted in a warm bath, and stirred thoroughly at 7,800 rpm with a Homogenizer (IKA Co. Ultra-Turrax T50) as 0.1 mol/L sodium hydrogen carbonate was added to increase the pH above 7.0.

A mixed solution of 3 parts of sodium dodecylbenzene sulfonate and 297 parts of deionized water was dripped in gradually to emulsify and disperse the mixture and obtain a polyester resin particle dispersion. When the particle size distribution of this polyester particle dispersion was measured with a particle size measurement apparatus (Horiba LA-920), the number-average particle diameter of the polyester resin particle contained in the dispersion was 0.25 μm, and no coarse particles larger than 1 μm were observed.

Preparing Wax Particle Dispersion

| | |
|---|---|
| Deionized water | 500 parts |
| Wax (Hydrocarbon wax: temperature of maximum | 250 parts |
| endothermic peak = 77° C.) | |

These materials were placed in a stainless-steel container, heated to 95° C. and melted in a warm bath, and stirred thoroughly at 7,800 rpm with a Homogenizer (IKA Ultra-Turrax T50) as 0.1 mol/L sodium hydrogen carbonate was added to increase the pH above 7.0.

A mixed solution of 5 parts of sodium dodecylbenzene sulfonate and 245 parts of deionized water was dripped in gradually to emulsify and disperse the mixture. When the particle size distribution of the wax particles contained in the wax particle dispersion was measured with a particle size measurement apparatus (Horiba LA-920), the number-average particle diameter of the wax particles contained in the dispersion was 0.35 μm, and no coarse particles larger than 1 μm were observed.

Preparing Colorant Particle Dispersion

| | |
|---|---|
| C.I. pigment blue 15:3 | 100 parts |
| Sodium dodecylbenzene sulfonate | 5 parts |
| Deionized water | 400 parts |

These were mixed and dispersed with a sand grinder mill. When the particle size distribution of the colorant particles contained in the colorant particle dispersion was measured with a particle size measurement apparatus (Horiba LA-920), the number-average particle diameter of the colorant particles contained in the dispersion was 0.2 μm, and no coarse particles larger than 1 μm were observed.

Manufacturing Core Particle

| | |
|---|---|
| Polyester resin particle dispersion | 500 parts |
| Colorant particle dispersion | 50 parts |
| Wax particle dispersion | 50 parts |
| Sodium dodecylbenzene sulfonate | 5 parts |

The polyester resin particle dispersion, the wax particle dispersion, and the sodium dodecylbenzene sulfonate were loaded into a reactor (1-liter flask, anchor blade with baffle), and uniformly mixed. Meanwhile, the colorant particle dispersion was uniformly mixed in a 500 mL beaker, and this was gradually added to the reactor under stirring to obtain a mixed dispersion. The resulting mixed dispersion was stirred as 1 part of an aqueous dispersion of ammonium sulfate (as solids) was dripped in to form aggregated particles.

After completion of dripping, the system was substituted with nitrogen, and the temperature was maintained at 50° C. for 1 hour and then at 55° C. for 1 hour.

The temperature was then raised to 90° C., maintained for 30 minutes, lowered to 63° C., and maintained for 3 hours to form fused particles. After the end of the specified time, the mixture was cooled to 30° C. at a cooling rate of 0.5° C. per minute and adjusted by addition of deionized water to obtain a core particle dispersion with a solids concentration of 25 mass %.

Manufacturing Toner Particle 13

An aqueous solution of an oxazoline group-containing resin (Nippon Shokubai Epocros WS-300, solids concentration of 10 mass %) was added to the flask in the amount shown in Table 2 relative to the above core particle dispersion.

Next, 6 mL of an aqueous ammonia solution with a concentration of 1 mass % was added to the flask.

The flask contents were then stirred at a rotational speed of 150 rpm as the temperature inside the flask was raised to 55° C. at a rate of 0.5° C./min. The flask contents were then stirred at 100 rpm as the temperature was maintained at 55° C. for 2 hours.

Next, an aqueous ammonia solution with a concentration of 1 mass % was added to the flask to adjust the pH of the flask contents to 7. The resulting slurry was then cooled to room temperature (about 25° C.), washed, filtered, and subjected to solid-liquid separation, and finally dried with a vacuum dryer to obtain a toner particle 13.

External Addition Step

A toner 13 was obtained in the same way as in the external addition step of the toner particle 1 except that the toner particle 13 was used.

Manufacturing Toner 14

A toner 14 was obtained in the same way as the toner 6 except that the resins were changed as shown in the Table 2 and no aqueous magnesium chloride solution was added to the flask when forming the shell of the toner 6.

Manufacturing Toner 15

A toner 15 was obtained in the same way as the toner 6 except that the resins were changed as shown in the Table 2 and no aqueous magnesium chloride solution was added to the flask when forming the shell of the toner 6, furthermore, 6 mL of acetic acid with a concentration of 99 mass % was added while the temperature inside the flask was being raised to 55° C. at a rate of 0.5° C./minute.

Manufacturing Toner 16

### Preparing Polyester Resin Particle Dispersion

A polyester resin particle dispersion was obtained as in the toner 13 using the polyester resin 1.

### Preparing Wax Particle Dispersion

A wax particle dispersion was prepared as in the toner 13.

### Preparing Colorant Particle Dispersion

A colorant particle dispersion was prepared as in the toner 13.

Preparing Core Particle

| | |
|---|---|
| Polyester resin particle dispersion | 500 parts |
| Colorant particle dispersion | 50 parts |
| Wax particle dispersion | 50 parts |
| Sodium dodecylbenzene sulfonate | 5 parts |

The polyester resin particle dispersion, the wax particle dispersion, and the sodium dodecylbenzene sulfonate were loaded into a reactor (1-liter flask, anchor blade with baffle), and uniformly mixed. Meanwhile, the colorant particle dispersion was uniformly mixed in a 500 mL beaker, and this was gradually added to the reactor under stirring to obtain a mixed dispersion. The resulting mixed dispersion was stirred as 3.0 parts of an ammonium sulfate aqueous dispersion (as solids) were dripped in to form aggregated particles.

After completion of dripping, the system was substituted with nitrogen, and the temperature was maintained at 50° C. for 1 hour and then at 55° C. for 1 hour.

The temperature was then raised to 90° C., maintained for 30 minutes, lowered to 63° C., and maintained for 3 hours to form fused particles. After the end of the specified time, the mixture was cooled to 30° C. at a rate of 0.5° C. per minute and adjusted by addition of deionized water to obtain a core particle dispersion with a solids concentration of 25 mass %.

Manufacturing Toner Particle 16

A toner particle 16 was obtained in the same way as the toner 13 except that the oxazoline group-containing resin was changed as shown in Table 2.

### External Addition Step

A toner 16 was obtained in the same way as in the external addition step of the toner particle 1 except that the toner particle 16 was used.

Manufacturing Toner 17

A toner 17 was obtained in the same way as the toner 1 except that 2.0 parts of methyl methacrylate as a polymerizable monomer for the shell and an aqueous solution of 0.2 parts of 2,2′-azobis(N-butyl-2-methylpropionamide) dissolved in 10 parts of deionized water as a water-soluble initiator were added when preparing the polymerizable monomer composition particle of the toner 1.

Manufacturing Toner 18

A toner 18 was obtained in the same way as the toner 1 except that 0.8 parts of methyl methacrylate and 7.2 parts of 2-vinyl-2-oxazoline as polymerizable monomers for the shell and an aqueous solution of 0.8 parts of 2,2′-azobis(N-butyl-2-methylpropionamide) dissolved in 20 parts of deionized water as a water-soluble initiator were added when preparing the polymerizable monomer composition particle of the toner 1, and an aqueous solution of 2.0 parts of magnesium chloride dissolved in 5.0 parts of deionized water was also added.

Manufacturing Toner 19

A toner 19 was obtained in the same way as the toner 6 except that the resins were changed as shown in Table 2 and an aqueous magnesium chloride solution of 0.2 parts (0.6 g) of magnesium chloride (as solids) dissolved in 10 g of deionized water was added to the flask when forming the shell of the toner 6.

Physical Properties of Toners 1 to 19

The various physical properties of the toners 1 to 19 above were measured, and the resulting physical property values are shown in Table 3. [Table 3]

TABLE 3

| | | | Oxazoline | Shell |
|---|---|---|---|---|
| | Polyvalent metal in shell | | concentration | thickness |
| | Type | Concentration | (mmol/g) | (nm) |
| Toner 1 | Mg | 0.0980 | 1.21 | 4.8 |
| Toner 2 | Mg | 0.3900 | 3.45 | 8.0 |
| Toner 3 | Mg | 0.4840 | 7.30 | 11.9 |
| Toner 4 | Mg | 0.0810 | 1.99 | 5.0 |
| Toner 5 | Ca | 0.0650 | 2.08 | 5.1 |
| Toner 6 | Mg | 0.0050 | 4.98 | 5.0 |
| Toner 7 | Mg | 0.0042 | 2.95 | 4.9 |
| Toner 8 | Mg | 0.0030 | 0.13 | 1.0 |
| Toner 9 | Mg | 0.0023 | 0.09 | 0.7 |
| Toner 10 | Mg | 0.0100 | 10.60 | 16.1 |
| Toner 11 | Mg | 0.0080 | 4.72 | 5.2 |
| Toner 12 | Mg | 0.0040 | 9.50 | 13.9 |
| Toner 13 | Al | 0.0070 | 5.11 | 5.0 |
| Toner 14 | — | — | 5.03 | 5.3 |
| Toner 15 | — | — | 0.15 | 5.2 |
| Toner 16 | — | — | 3.10 | 5.2 |
| Toner 17 | Mg | 0.0150 | — | — |
| Toner 18 | Al | 0.5300 | 6.90 | 11.5 |
| Toner 19 | Mg | 0.0007 | 0.08 | 0.7 |

The concentrations of the polyvalent metals in the shells are atomic % values.

Image Evaluation

A Hewlett Packard color laser printer (HP LaserJet Enterprise Color M652n) was used as the image-forming apparatus, and modified so that the process speed was 300 mm/sec. An HP 656X genuine LaserJet toner cartridge (cyan) was used as the cartridge.

The commercial toner was removed from the cartridge, which was then cleaned by air blowing and filled with 300 g of the toner for evaluation. The following evaluations were performed using the above image-forming apparatus and cartridge.

The evaluations were performed with the above cartridge installed in the cyan station and dummy cartridges in the other stations. The various potential settings were also changed to allow developing with a positively charged toner.

Evaluating Fogging Initially and After Toner was Left in Harsh Environment

For the toner after being left in a harsh environment, 300 g of toner was left for 30 days in a thermostatic tank at 40° C., 95% RH, and a fogging evaluation was performed using the initial toner before being left in the harsh environment and the toner after being left in the harsh environment. For the evaluation conditions, the reflectance (%) of the non-image part was measured in a high-temperature and high-humidity environment (32° C./85% RH) with a Reflectometer Model TC-6DS (Tokyo Denshoku).

Fogging was evaluated using a value (%) obtained by subtracting the resulting reflectance value (%) from a reflectance value measured in the same way on unused printer paper (standard paper). The smaller the value, the more image fogging has been suppressed. The evaluation was performed using plain paper (HP Brochure Paper 200 g, Glossy, HP Corp., 200 g/m²) in gloss paper mode.

Evaluation Standard

A: Less than 0.5%
B: At least 0.5% and less than 1.5%
C: At least 1.5% and less than 3.0%
D: At least 3.0%

Development Streaks

30,000 sheets of a horizontal line image with image coverage of 1% were printed in a high-temperature and high-humidity environment (32° C./85% RH) as a printout test. After completion of printing, a halftone image (toner laid-on level of 0.3 mg/cm²) was printed out on letter size Xerox 4200 paper (Xerox Co., 75 g/m²), the presence or absence of vertical streaks on the halftone image in the direction of paper discharge was observed, and durability was evaluated as follows.

Evaluation Standard

A: No streaks
B: From 1 to 3 vertical streaks in the paper discharge direction on the halftone image part
C: From 4 to 6 vertical streaks in the paper discharge direction on the halftone image part
D: At least 7 vertical streaks in the paper discharge direction on the halftone image part, or streaks at least 0.5 mm in width

Regulation Error

20,000 sheets of a horizontal line image with image coverage of 1% were printed in a low-temperature and low-humidity environment (15° C., 10% RH) as a printout test, and after completion of printing, the amount of toner clumps and spotted streaks appearing on a halftone image with a toner laid-on level of 0.3 mg/cm² was evaluated.

A: No streaks or clumps
B: No spotted streaks, but small toner clumps in 2 or 3 places
C: Some spotted streaks at edges, or small toner clumps in 4 or 5 places
D: Spotted streaks throughout, or 5 or more small toner clumps or obvious toner clumps

### Examples 1 to 13

In Examples 1 to 13, the above evaluations were each performed using the toners 1 to 13 as the toner. The evaluations results are shown in Table 4.

### Comparative Examples 1 to 6

In Comparative Examples 1 to 6, the above evaluations were each performed using the toners 14 to 19 as the toner. The evaluation results are shown in Table 4. [Table 4]

TABLE 4

| | | Fogging | | | | | |
|---|---|---|---|---|---|---|---|
| | | | | After | | | |
| | | | | being | | | |
| | | | | left in | | | |
| | | | | harsh | | | Regulation |
| | | Initial | | environment | | Streaks | error |
| | | Rank | % | Rank | % | Rank | Rank |
| Example 1 | Toner 1 | A | 0.1 | A | 0.1 | A | A |
| Example 2 | Toner 2 | B | 1.0 | B | 1.1 | A | A |
| Example 3 | Toner 3 | C | 2.8 | C | 2.7 | A | B |
| Example 4 | Toner 4 | A | 0.3 | A | 0.2 | B | A |
| Example 5 | Toner 5 | A | 0.4 | B | 0.6 | A | A |
| Example 6 | Toner 6 | B | 0.9 | B | 1.1 | B | A |
| Example 7 | Toner 7 | B | 1.0 | B | 1.3 | B | A |
| Example 8 | Toner 8 | C | 2.1 | C | 2.5 | B | A |
| Example 9 | Toner 9 | C | 2.4 | C | 2.8 | B | A |
| Example 10 | Toner 10 | B | 1.4 | B | 1.3 | C | C |
| Example 11 | Toner 11 | B | 0.8 | B | 0.9 | C | A |
| Example 12 | Toner 12 | B | 1.3 | C | 1.7 | C | B |
| Example 13 | Toner 13 | B | 1.2 | C | 1.5 | B | A |
| Comparative Example 1 | Toner 14 | B | 1.2 | D | 3.5 | B | A |
| Comparative Example 2 | Toner 15 | C | 2.4 | D | 3.2 | B | A |
| Comparative Example 3 | Toner 16 | B | 1.3 | D | 3.4 | B | A |
| Comparative Example 4 | Toner 17 | D | 3.3 | D | 4.0 | A | A |
| Comparative Example 5 | Toner 18 | D | 3.1 | D | 3.3 | A | D |
| Comparative Example 6 | Toner 19 | C | 2.6 | D | 3.2 | B | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-185498, filed Nov. 6, 2020, which is hereby incorporated by reference herein in its entirety.

What is claimed is:

1. A toner comprising a toner particle comprising
a core particle comprising a binder resin, and
a shell on a surface of the core particle, wherein
the shell comprises an oxazoline group and a polyvalent metal, and
in an electron image of a cross-section of the toner particle taken with a transmission electron microscope, the polyvalent metal has atomic concentration C(M) of 0.0010 to 0.5000 atomic % as measured by energy dispersive X-ray analysis of the shell.

2. The toner according to claim 1, wherein the oxazoline has concentration of 0.10 to 10.00 mmol/g as measured by time-of-flight secondary ion mass spectrometry (TOF-SIMS) of the toner particle.

3. The toner according to claim 1,
wherein the shell comprises a resin comprising an oxazoline group, and
the resin containing the oxazoline group comprises a structure represented by formula (1) below: 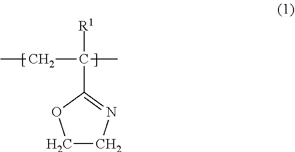
Where, in the formula (1), R′ represents a hydrogen atom or alkyl group.

4. The toner according to claim 1, wherein the polyvalent metal comprises at least one selected from the group consisting of Mg, Al and Ca.

5. The toner according to claim 1, wherein the shell has an average value of thickness of 1.0 to 15.0 nm.

6. The toner according to claim 1, wherein the binder resin comprises at least one selected from the group consisting of a vinyl resin and a polyester resin.

7. The toner according to claim 1, wherein the binder resin comprises a styrene-acrylic resin.

8. The toner according to claim 1, wherein the binder resin comprises a polyester resin.

9. The toner according to claim 8, wherein the polyester resin has an acid value of 3.0 to 30.0 mg KOH/g.

10. The toner according to claim 1, wherein the polyvalent metal is Mg derived from magnesium hydroxide.

11. The toner according to claim 1, wherein the polyvalent metal is Al derived from aluminum sulfate.

12. The toner according to claim 1, wherein the polyvalent metal is Mg derived from magnesium chloride.
